(19) United States
(12) Patent Application Publication
(10) Pub. No.: US 2005/0193532 A1
(43) Pub. Date: Sep. 8, 2005

(54) CONNECTOR HAVING QUICK RELEASE LOCK

(76) Inventor: Vincent Chang, Taichung (TW)

Correspondence Address: Charles E. Baxley, ESQ, 90 John Street, 3rd Floor, New York, NY, 10038, US

(21) Appl. No.: 10/795,164

(22) Filed: Mar. 3, 2004

(51) Int. Cl. F16B 45/00

(52) U.S. Cl. 24/600.9

(57) ABSTRACT

A connector includes a mouth formed between a receiving end and an attaching end, and a projection extended from the receiving end. A sleeve has one end rotatably and slidably attached to the attaching end of the connector member, and the other end having one or more lock notches to selectively receive the projection and to detachably lock the sleeve to the connector member. A spring member may be used to bias the other end of the sleeve toward the receiving end of the connector member, to retain an engagement of the projection of the connector member in the lock notch of the sleeve.

### BACKGROUND OF THE INVENTION

1. Field of the Invention

The present invention relates to a connector, and more particularly to a connector having a quick release lock device.

2. Description of the Prior Art

Various kinds of typical connectors have been developed for connecting straps, chains, or the like, and comprise a hook body having a mouth for receiving various objects, and a lock member actuatable to enclose the mouth, and to prevent the objects from being disengaged from the hook body via the mouth of the hook body.

For example, U.S. Pat. No. 2,010,277 to Smith discloses one of the typical connectors and comprises a notch formed in a housing, and a tubular body slidably received in the housing and having a hook to selectively enclose or block the notch of the housing, and lockable to the housing with a pair of spring biased pins. However, the pins may not be easily actuated or operated by the users.

U.S. Pat. No. 2,124,276 to Steigenberger discloses another typical connector comprising a mouth formed in a hook which includes a guide slidably received in a sleeve, and the sleeve includes a nose to selectively enclose or block the mouth of the hook. However, the hook may not be solidly secured or locked to the sleeve and may be opened relative to the sleeve inadvertently.

U.S. Pat. No. 2,826,798 to Kahl et al. discloses a further typical connector comprising a cylindrical body slidably received in a tubular member, and including a ring having a throat formed therein. The cylindrical body includes a pair of spring biased balls to engage with apertures of the tubular member, to lock the cylindrical body to the tubular member. However, the spring biased balls may have a good chance to be disengaged from the apertures of the tubular member.

U.S. Pat. No. 3,365,759 to Molzan et al. discloses a still further typical connector comprising a stem slidably received in a sleeve, and including two spring biased balls to engage with the sleeve, and to position the stem to the sleeve, and including a pin to engage with a lock slot of the sleeve. However, the stem may not be easily engaged onto or attached onto various objects.

U.S. Pat. No. 3,861,007 to Silverman discloses the other typical connector comprising an elongate body slidably received in a sleeve, and including a spring detent to engage with the sleeve, and to lock the elongate body to the sleeve. However, when the spring detent is depressed or actuated by the users, the fingers of the users may have a good chance to be clamped and hurt by the sleeve and the elongate body.

U.S. Pat. No. 3,983,607 to Stevens, Jr. discloses a further typical connector comprising a latch member slidably biased to enclose a hook throat of a hook, and a torsion spring housing attached onto a shank of the hook and having a drive pin engageable with the torsion spring housing. However, a complicated lock configuration is required to be attached onto the hook, in order to retain the latch member to the hook.

The present invention has arisen to mitigate and/or obviate the afore-described disadvantages of the conventional connectors.

### SUMMARY OF THE INVENTION

The primary objective of the present invention is to provide a connector including a quick release lock device to allow the connector to be easily operated by the users.

In accordance with one aspect of the invention, there is provided a connector comprising a connector member including a space formed therein, and including a mouth defined between a receiving end and an attaching end, and including a projection extended from the receiving end thereof, a sleeve including a first end rotatably and slidably attached to the attaching end of the connector member, and including a second end having at least one lock notch formed therein, to selectively receive the projection of the connector member, and the sleeve being rotatable relative to the connector member to selectively engage the projection of the connector member into the lock notch of the sleeve, and to detachably lock the sleeve to the connector member, and means for biasing the second end of the sleeve toward the receiving end of the connector member, to retain an engagement of the projection of the connector member in the lock notch of the sleeve.

The connector member includes a flange extended from the attaching end thereof, the sleeve includes a peripheral rib extended from the first end to engage with the flange and to slidably retain the sleeve to the connector member, and to prevent the sleeve from being disengaged from the connector member.

The connector member includes a flange extended from the receiving end thereof, and engageable with the second end of the sleeve, to limit a relative movement between the sleeve and the connector member. The connector member includes an orifice formed in the receiving end thereof to receive the projection.

The sleeve includes a stop engaged therein, the biasing means includes a spring member engaged between the stop and the attaching end of the connector member to bias the second end of the sleeve toward the receiving end of the connector member.

The sleeve includes at least one peripheral recess or a bellows-shaped structure formed therein to receive the stop. The stop includes an inclined peripheral surface formed thereon to allow the stop to be engaged into the peripheral recess of the sleeve.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a connector in accordance with the present invention;

FIG. 2 is a perspective view of the connector;

FIG. 3 is a cross sectional view of the connector, taken along lines 3-3 of FIG. 2;

FIG. 4 is a cross sectional view similar to FIG. 3, illustrating the operation of the connector;

FIG. 5 is an exploded view similar to FIG. 1, illustrating the other embodiment of the connector;

FIG. 6 is an exploded view similar to FIGS. 1, 5, illustrating another embodiment of the connector;

FIG. 7 is an exploded view similar to FIGS. 1, 5-6, illustrating a further embodiment of the connector;

FIG. 8 is an exploded view similar to FIGS. 1, 5-7, illustrating a still further embodiment of the connector;

FIG. 9 is a cross sectional view similar to FIGS. 3 and 4, illustrating the further embodiment of the connector; and

FIG. 10 is a cross sectional view similar to FIGS. 3, 4, and 9, illustrating the other arrangement of the connector.

### DETAILED DESCRIPTION OF THE PREFERRED EMBODIMENT

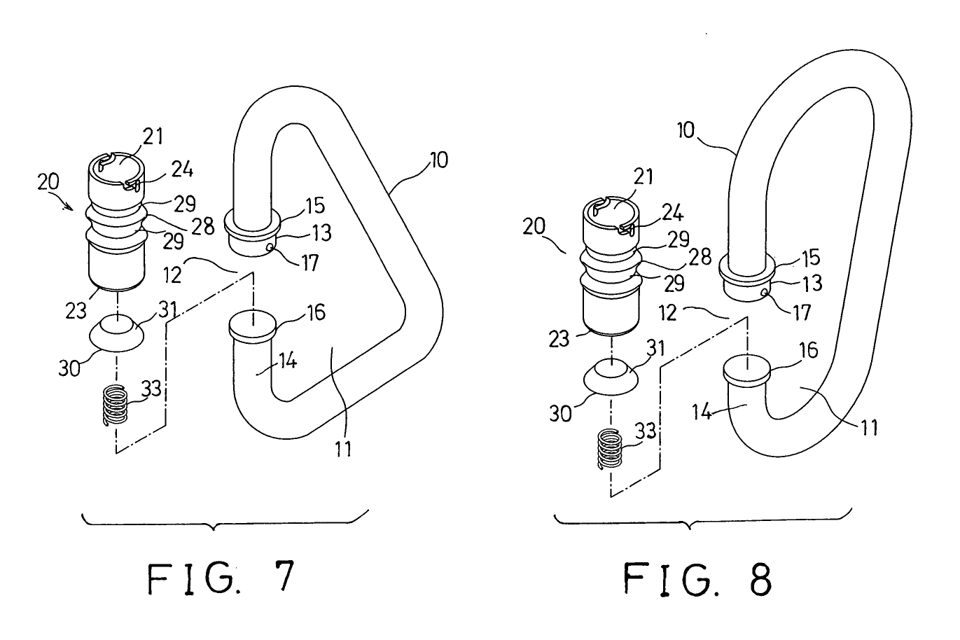

Referring to the drawings, and initially to FIGS. 1-3, a connector in accordance with the present invention comprises a connector member 10 made of or formed with a single round metal rod and including a substantially ring or C-shaped structure having a space 11 formed therein, and having a mouth 12 formed or defined between a receiving end 13 and an attaching end 14. The connector member 10 may also be formed into various shapes (FIGS. 7, 8).

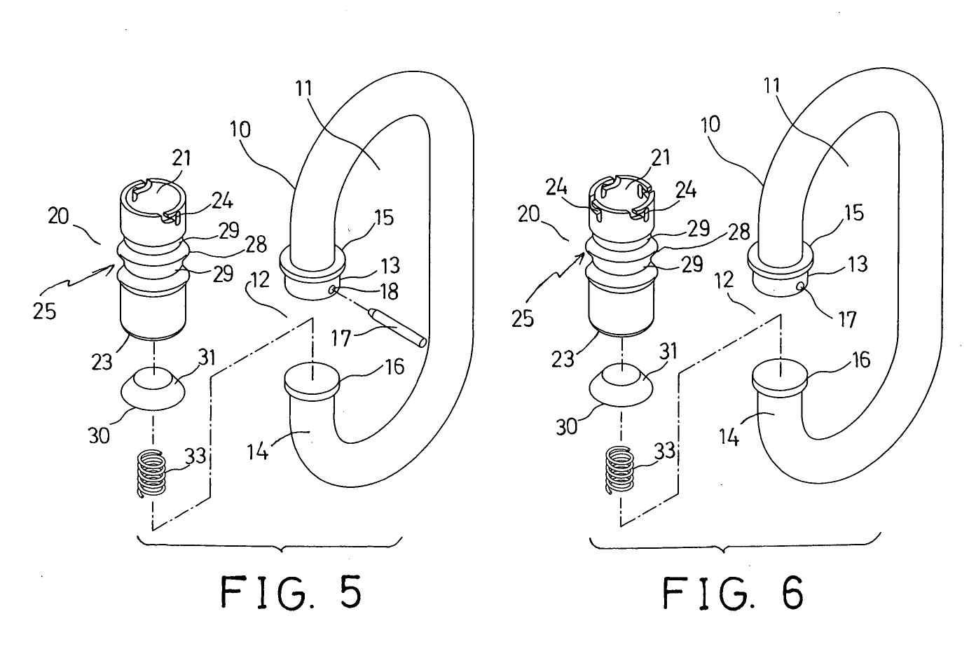

Each of the ends 13, 14 of the connector member 10 includes a peripheral flange 15, 16 extended radially out therefrom. The receiving end 13 of the connector member 10 includes a projection or a spring biased projection 17 engaged therein and slightly extended out therefrom. For example, as shown in FIG. 5, the connector member 10 may include an orifice 18 formed therein to receive the projection 17.

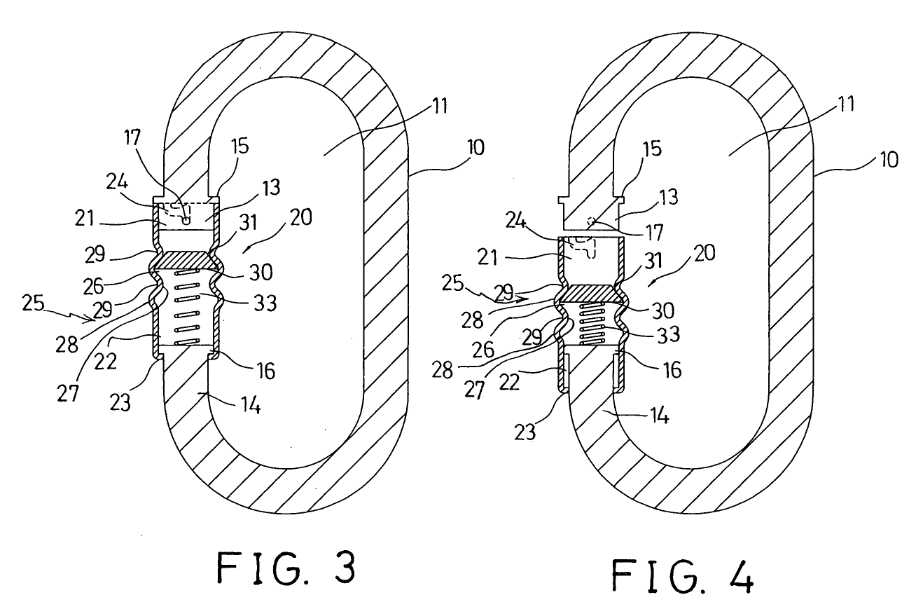

A sleeve 20 includes two ends 21, 22 for slidably receiving the ends 13, 14 of the connector member 10 respectively (FIGS. 3, 4), and includes a peripheral rib 23 extended inward from the lower end 22 thereof, to engage with the peripheral flange 16 of the connector member 10, and to retain the sleeve 20 to the connector member 10, and to prevent the sleeve 20 from being disengaged from the connector member 10.

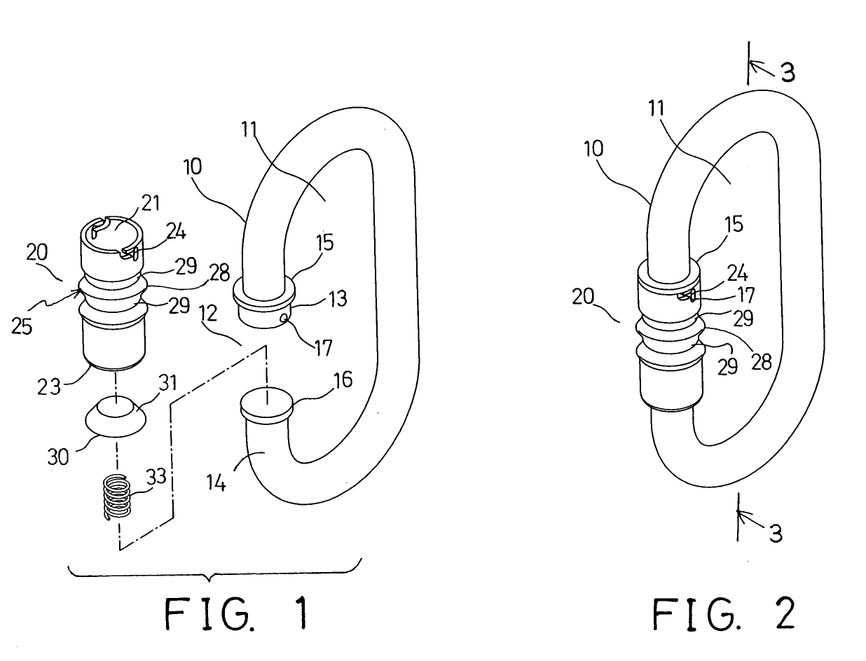

The sleeve 20 includes one or more, such as two lock notches 24 (FIGS. 1, 5, 7, 8), or four lock notches 24 (FIG. 6) formed in the upper end 21 thereof, to selectively receive the projection 17 of the connector member 10 (FIGS. 2-4), and to detachably lock the sleeve 20 to the connector member 10. The upper end 21 of the sleeve 20 may be engaged with the peripheral flange 15 of the connector member 10 to limit the relative movement between the sleeve 20 and the connector member 10.

The sleeve 20 includes a bellows-shaped structure 25 formed in the middle portion thereof and having one or more peripheral recesses 26 formed in inner portion thereof and defined between peripheral bulges 27, and having one or more peripheral swellings 28 formed on outer portion thereof and defined between peripheral depressions 29.

A stop 30 is engaged in the sleeve 20, and includes a tapered or inclined upper peripheral surface 31 formed thereon for allowing the stop 30 to be easily engaged into the sleeve 20, and to be engaged in the intermediate bellows-shaped structure 25 of the sleeve 20. The stop 30 may be stably seated or retained in either of the peripheral recesses 26 of the sleeve 20 (FIGS. 3, 4).

A spring member 33 is received in the lower end 22 of the sleeve 20, and engaged between the attaching end 14 of the connector member 10 and the stop 30, to bias and force the upper end 21 of the sleeve 20 toward and to engage with the receiving end 13 of the connector member 10, and thus to maintain the engagement of the projection 17 of the connector member 10 in either of the lock notches 24 of the sleeve 20 (FIG. 3).

It is to be noted that the sleeve 20 is rotatably engaged onto the ends 13, 14 of the connector member 10, and may be easily operated or rotated relative to the connector member 10 in an active direction by users, to engage the projection 17 into the lock notches 24 of the sleeve 20 (FIG. 3), and to detachably lock the sleeve 20 to the connector member 10. The projection 17 may also be easily disengaged from the lock notches 24 of the sleeve 20 (FIG. 4) by rotating the sleeve 20 relative to the connector member 10 in an reverse direction.

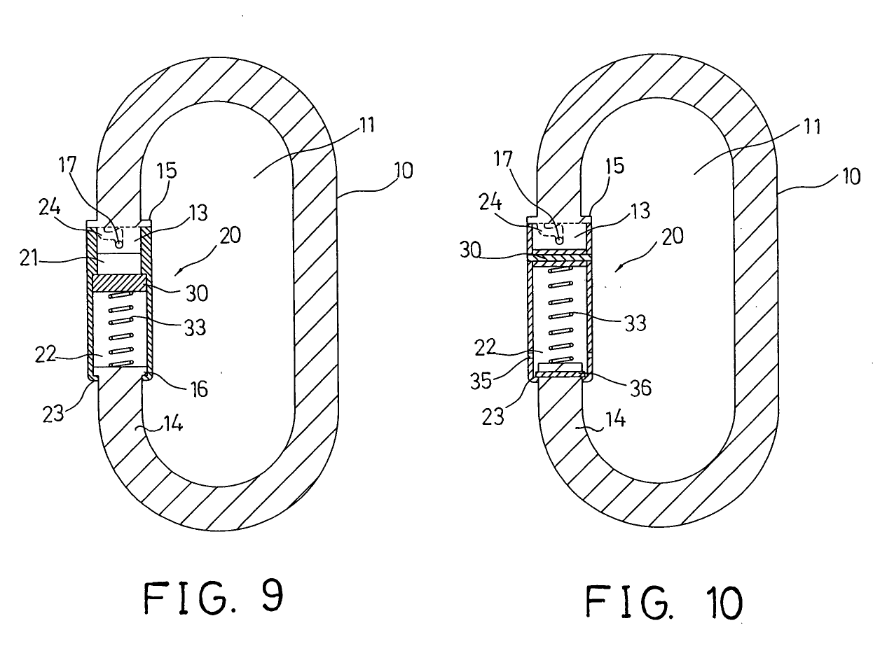

Alternatively, as shown in FIG. 9, the stop 30 may simply be disposed or anchored in the intermediate portion of the sleeve 20 to engage with the spring member 33. As shown in FIG. 10, the sleeve 20 may include the stop 30 integrally formed in the middle portion thereof to engage with the spring member 33, and may include an aperture 35 formed therein for engaging a pin 36 through the attaching end 14 of the connector member 10, and to allow the pin 36 to engage with the peripheral rib 23 of the sleeve 20.

Accordingly, the connector includes a quick release lock device to allow the connector to be easily operated by the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A connector comprising:
a connector member including a space formed therein, and including a mouth defined between a receiving end and an attaching end, and including a projection extended from said receiving end thereof,
a sleeve including a first end rotatably and slidably attached to said attaching end of said connector member, and including a second end having at least one lock notch formed therein, to selectively receive said projection of said connector member, and said sleeve being rotatable relative to said connector member to selectively engage said projection of said connector member into said at least one lock notch of said sleeve, and to detachably lock said sleeve to said connector member, and
means for biasing said second end of said sleeve toward said receiving end of said connector member, to retain an engagement of said projection of said connector member in said at least one lock notch of said sleeve.

2. The connector as claimed in claim 1, wherein said connector member includes a flange extended from said attaching end thereof, said sleeve includes a peripheral rib extended from said first end thereof, to engage with said flange of said connector member, and to slidably retain said sleeve to said connector member, and to prevent said sleeve from being disengaged from said connector member.

3. The connector as claimed in claim 1, wherein said connector member includes a flange extended from said receiving end thereof, and engageable with said second end of said sleeve, to limit a relative movement between said sleeve and said connector member.

4. The connector as claimed in claim 1, wherein said connector member includes an orifice formed in said receiving end thereof to receive said projection.

5. The connector as claimed in claim 1, wherein said sleeve includes a stop engaged therein, said biasing means includes a spring member engaged between said stop and said attaching end of said connector member to bias said second end of said sleeve toward said receiving end of said connector member.

6. The connector as claimed in claim 5, wherein said sleeve includes at least one peripheral recess formed therein to receive said stop.

7. The connector as claimed in claim 6, wherein said stop includes an inclined peripheral surface formed thereon to allow said stop to be engaged into said at least one peripheral recess of said sleeve.

8. The connector as claimed in claim 5, wherein said sleeve includes a bellows-shaped structure formed therein to receive said stop.
